(19) United States
(12) Patent Application Publication
(10) Pub. No.: US 2023/0371527 A1
(43) Pub. Date: Nov. 23, 2023

(54) PEST REPELLENT

(71) Applicant: Native Earth Organics, LLC, Lakewood, CO (US)

(72) Inventors: Sarah Marcogliese, Lakewood, CO (US); Charles Murphy, Lakewood, CO (US); Morgan Ward, Denver, CO (US)

(21) Appl. No.: 18/321,410

(22) Filed: May 22, 2023

Related U.S. Application Data
(60) Provisional application No. 63/344,829, filed on May 23, 2022.

(51) Int. Cl. A01N 65/38; A01N 65/28; A01N 25/04; A01P 17/00

(52) U.S. Cl. CPC A01N 65/38; A01N 65/28; A01N 25/04; A01P 17/00

(57) ABSTRACT

The present disclosure relates to pest repellent compositions and methods of using and applying the same to repel pests, including the Japanese beetle. In one example, a composition for use in repelling pests from vegetation includes two or more essential oils, a mixing agent, and a surfactant. The two or more essential oils may include at least capsaicin oil in a concentration that is effective at reducing or eliminating pest activity on the vegetation without harming the vegetation. The pest activity may include Japanese beetle activity.

### CROSS REFERENCE TO RELATED APPLICATIONS

The present application claims the benefit of priority to U.S. Provisional Patent Application No. 63/344,829, entitled “Pest Repellent,” filed May 23, 2022, the entirety of which is hereby incorporated by reference herein for all purposes.

### TECHNICAL FIELD

The technology described herein relates generally to a pest repellent, specifically a pest repellent that is effective in repelling the Japanese beetle.

### BACKGROUND

The Japanese beetle is a highly destructive plant pest. Specifically, Japanese beetles feed on the leaves, flowers, and fruits of several hundred species of fruit trees, ornamental trees, shrubs, vines, and field and vegetable crops. The grubs develop in the soil and feed on roots, which can lead to destruction of lawns, parks, golf courses, and pastures. Adult consumption of foliage results in skeletonized leaves and large holes in leaves.

Various pesticides are effective against other pests, but fail to control Japanese beetle activity. Pesticides that are targeted to control the Japanese beetle are often ineffective, environmentally harmful, toxic, aesthetically unpleasing, and negatively impact other non-harmful insects such as bees.

The information included in this Background section of the specification, including any references cited herein and any description or discussion thereof, is included for technical reference purposes only and is not to be regarded subject matter by which the scope of the invention as defined in the claims is to be bound.

### SUMMARY

The disclosed technology includes a pest repellent and methods of use of the same. Embodiments of the present disclosure may include a composition for use in repelling pests from vegetation. The composition may include two or more essential oils, a mixing agent, and a surfactant. The two or more essential oils may include capsaicin oil in a concentration that is effective at reducing or eliminating pest activity on the vegetation without harming the vegetation. The pest activity may include Japanese beetle activity.

Additionally or separately, the capsaicin oil may be no more than 10.6% of the composition. Additionally or separately, the capsaicin oil may be no more than 400 mL per 1 gallon of the composition. Additionally or separately, the two or more essential oils may further include eucalyptus oil. Additionally or separately, the capsaicin oil and eucalyptus oil may be included in a ratio of 2:1. Additionally or separately, the two or more essential oils may include one or more essential oils from the genera Eucalyptus, Mentha, Artemisia, and Cedrus. Additionally or separately, the two or more essential oils may include one or more of eucalyptus oil, wormwood oil, peppermint oil, wintergreen oil, spearmint oil, mugwort oil, tea tree oil, and cedarwood oil.

Additionally or separately, the composition may be a concentrated solution. Additionally or separately, the capsaicin oil is about 9.5% to about 10.6% of the concentrated solution, and the two or more essential oils may include one or more of eucalyptus oil that is about 4% to about 10% of the concentrated solution, wormwood oil that is about 1% to about 6% of the concentrated solution, peppermint oil that is about 1% to about 6% of the concentrated solution, wintergreen oil that is about 1% to about 6% of the concentrated solution, and mugwort oil that is about 1% to about 6% of the concentrated solution. Additionally or separately, the two or more essential oils in a gallon of concentrated solution may include 400 mL capsaicin oil, 200 mL eucalyptus oil, 120 mL wormwood oil, 100 mL peppermint oil, 100 mL wintergreen oil, and 80 mL mugwort oil. Additionally or separately, the concentrated solution is mixed with water in a ratio of 1 to 2 ounces of concentrated solution to 1 gallon of water, forming a diluted solution that is applied to a plant surface to repel pests including the Japanese beetle. Additionally or separately, the mixing agent may include 99% isopropyl alcohol that is about 15% to about 25% of the concentrated solution, and the surfactant may include glycerin that is about 45% to about 55% of the concentrated solution.

Other examples or embodiments of the present disclosure may include a method of treating vegetation to repel pests. The method may include applying a pest repellent composition to one or more plants to repel one or more pests. The pest repellent composition may include two or more essential oils, a mixing agent, and a surfactant. The two or more essential oils may include capsaicin oil in a concentration of no more than about 10.6% of the composition.

Additionally or separately, the capsaicin oil may be in a concentration of no less than about 9.5% of the composition to effectively reduce a presence of Japanese beetles on the one or more plants. Additionally or separately, the one or more pests may include Japanese beetles, and applying the pest repellent composition to the one or more plants may include applying the pest repellent composition at a time including at least one of: before Japanese beetle activity is present; a morning time when Japanese beetle activity is present; when temperatures are at or below 70 degrees Fahrenheit; and a high activity period for Japanese beetles, wherein the pest repellent composition is applied more frequently during the high activity period. Additionally or separately, the method may further include diluting the pest repellent composition with water prior to applying the pest repellent composition. Additionally or separately, the two or more essential oils may further include eucalyptus oil.

Additional examples or embodiments of the present disclosure may include a method of treating vegetation to effectively repel the Japanese beetle. The method may include applying a pest repellent composition to one or more plants to repel the Japanese beetle. The pest repellent composition may include two or more essential oils, a mixing agent, and a surfactant. The two or more essential oils may include capsaicin oil in a concentration of no more than about 10.6% of the composition.

Additionally or separately, applying the pest repellent to the one or more plants may include applying the pest repellent before Japanese beetle activity is present to prevent the Japanese beetle from landing on the one or more plants. Additionally or separately, an appearance of the one or more plants is unaffected by applying the pest repellent to the one or more plants.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and implementations and illustrated in the accompanying drawings.

### BRIEF DESCRIPTION OF THE DRAWINGS

FIG. 1 is a block diagram illustrating a pest repellent composition, according to one or more embodiments.

FIG. 2 is a flow chart illustrating a method of treating vegetation with a pest repellent solution.

### DETAILED DESCRIPTION

The present disclosure relates to pest repellent compositions and methods of using and applying the same. In several embodiments, the disclosed pest repellent is natural, non-toxic, non-carcinogenic, environmentally friendly, stable, and highly effective at preventing damage to vegetation caused by pests, particularly the Japanese beetle.

Conventional pesticides often include a combination of chemicals intended to kill or otherwise adversely affect living organisms, such as mice, deer, and insects. Such pesticides can be harmful to the environment, humans, and other non-targeted living organisms, such as bees. Various insecticides that are aimed at eliminating certain insects, such as mites, aphids, and mosquitos, fail to eliminate the Japanese beetle. Insecticides that are specifically aimed to eliminate the Japanese beetle often include harsh chemicals intended to kill the insect, which end up killing other non-harmful insects as well and harming the environment (e.g., causing harm to the soil). Some insecticides that include natural ingredients are ineffective or leave aesthetically unpleasing residue on the vegetation, which is undesirable for lawn and garden maintenance. For example, certain bacteria are used to target the grubs of Japanese beetles that develop in the soil; however, such bacteria are ineffective at eliminating harm to the plants caused by Japanese beetles that come from other untreated areas (e.g., a neighbor's untreated lawn).

In several embodiments, the disclosed pest repellent is made of natural ingredients that effectively repel various pests, including the Japanese beetle, without harming the environment or other non-targeted living organisms (e.g., bees) and omits harsh, toxic chemicals typically found in conventional pesticides. For example, a disclosed pest repellent may repel mites, mealybugs, aphids, scale bugs, flea beetles, caterpillars, thrips, whiteflies, and other pests in addition to the Japanese beetle. In several embodiments, the disclosed pest repellent prevents pests, such as the Japanese beetle, from landing on vegetation and/or biting or eating the vegetation. In several embodiments, the disclosed pest repellent effectively eliminates pests without impacting vegetation aesthetics (e.g., vegetation appearance remains intact or is unaffected by the pest repellent).

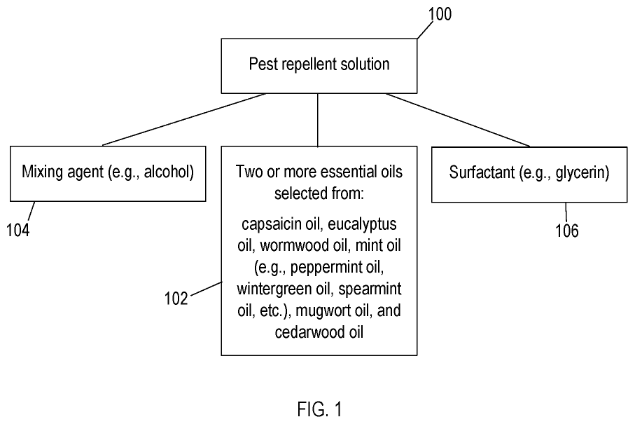

In several embodiments, the pest repellent includes two or more essential oils, a mixing agent, and a surfactant. FIG. 1 shows a block diagram depicting an exemplary pest repellent solution 100. As shown, the pest repellent solution 100 includes two or more essential oils 102, a mixing agent 104 (e.g., alcohol), and a surfactant 106 (e.g., glycerin). The two or more essential oils 102 may include two or more of the following essential oils: capsaicin oil, eucalyptus oil, wormwood oil, mint oil (e.g., peppermint oil, wintergreen oil, spearmint oil, etc.), mugwort oil, tea tree oil, and cedarwood oil. In some embodiments, the two or more essential oils 102 include capsaicin oil and one or more other essential oil. In some embodiments, the two or more essential oils 102 include capsaicin oil and eucalyptus oil. In some embodiments, the capsaicin oil and eucalyptus oil are included in a ratio of 2:1. The two or more essential oils 102 may include oils from the following genera: Capsicum, Eucalyptus, Mentha, Artemisia, Melaleuca, and Cedrus. The essential oils may function as a pest repellent or deterrent and are particularly effective in repelling the Japanese beetle. It is contemplated that one or more essential oils may be included to maintain the integrity or purity of the pest repellent. For example, tea tree oil may be included for mold and mildew prevention.

It is contemplated that the concentrated pest repellent solution may include about 9.5% to about 10.6% capsaicin oil. The concentrated solution may include about 4% to about 10% eucalyptus oil. The concentrated solution may include about 1% to about 6% wormwood oil. The concentrated solution may include about 1% to about 6% peppermint oil. The concentrated solution may include about 1% to about 6% wintergreen oil. The concentrated solution may include about 1% to about 6% mugwort oil. In an exemplary embodiment, the concentrations of essential oils in the concentrated pest repellent are 10.6% capsaicin oil, 5.3% eucalyptus oil, 3.2% wormwood oil, 2.6% peppermint oil, 2.6% wintergreen oil, and 2.1% mugwort oil.

In an exemplary embodiment, the concentrations of essential oils in a gallon of concentrated pest repellent are 400 mL capsaicin oil, 200 mL eucalyptus oil, 120 mL wormwood oil, 100 mL peppermint oil, 100 mL wintergreen oil, and 80 mL mugwort oil. The concentrations of the essential oils may be adjusted. For example, more or less eucalyptus oil may be included. For example, where less capsaicin oil is included, more eucalyptus oil may be used. As another example, the oils may be substituted for one another or other oils may be substituted in. For example, wintergreen oil may be replaced with peppermint oil, such that the concentrated solution includes 200 mL of peppermint oil per gallon, or vice versa (e.g., 200 mL of wintergreen oil instead of peppermint oil). One or more of wormwood oil, peppermint oil, wintergreen oil, and mugwort oil may be substituted with cedarwood oil. One or more of the essential oils may be substituted with tea tree oil.

The addition of more essential oils and the specific combination of essential oils in the pest repellent mixture may increase the effectiveness of the disclosed pest repellent. As one example, the addition of capsaicin oil may increase the effectiveness of the pest repellent against the Japanese beetle. The concentration of capsaicin oil may be selected to increase the effectiveness of the pest repellent (e.g., eliminate or nearly eliminate Japanese beetle activity or prevent Japanese beetles from landing on treated vegetation) while minimizing harm to the plant or vegetation. For example, too high of a concentration of capsaicin oil may burn the plant, while too low of a concentration of capsaicin oil may be ineffective at reducing or eliminating Japanese beetle activity. In the above exemplary embodiment, 400 mL of capsaicin oil per gallon of concentrated pest repellent is an amount that is effective at controlling the Japanese beetle while avoiding harm to the plant. It is contemplated that the capsaicin oil may be adjusted based on plant species and plant sensitivity. For example, a more sensitive plant may be more susceptible to harm (e.g., burning) with a higher concentration of capsaicin oil. In this case, the concentration of capsaicin oil may be reduced for more effective treatment with minimal harm to the plant (e.g., less than 400 mL per gallon).

In several embodiments, the mixing agent and/or surfactant included in the pest repellent contribute to its stability and effectiveness. The surfactant may be a surface-active agent that helps the pest repellent adhere to a surface (e.g., plant surfaces). For example, the surfactant may prevent or limit the pest repellent from washing off the vegetation when it rains. In several embodiments, the surfactant is glycerin (e.g., as depicted by surfactant 106 in FIG. 1). In several embodiments, the mixing agent is an alcohol, such as isopropyl alcohol (e.g., as depicted by mixing agent 104 in FIG. 1). The concentrated solution may include about 15% to about 25% 99% isopropyl alcohol. The concentrated solution may include about 45% to about 55% glycerin. In an exemplary embodiment, the concentrations of mixing agent and surfactant in the concentrated pest repellent are 21.1% 99% isopropyl alcohol and 52.8% glycerin. In an exemplary embodiment, the concentrations of mixing agent and surfactant in a gallon of concentrated pest repellent are 800 mL 99% isopropyl alcohol and 2000 mL glycerin.

In several embodiments, the pest repellent is a concentrated solution. The pest repellent may be stable in a concentrated form. For example, in concentrated form, the pest repellent may have a shelf life of several years.

In several embodiments, the concentrated pest repellent is mixed with water in a diluted solution (e.g., for application). For example, the concentrated pest repellent may be mixed with water in a ratio of 1:128. As an example, a diluted solution may include about 1 to about 3 ounces of concentrated solution (e.g., 1 ounce or 2 ounces of concentrated solution) mixed with 1 gallon of water. The diluted solution may be applied to vegetation. The diluted solution may have an effective amount of the concentrated solution to reduce or eliminate pests while reducing harm to the plant. For example, the diluted solution may allow passage of carbon dioxide and oxygen to and from the plant and may prevent burning that can occur from the concentrated essential oils magnifying the effects of the sun.

In several embodiments, the pest repellent is stable. The pest repellent may remain effective and in its current form (e.g., without components separating) regardless of changes in temperature. For example, the pest repellent may maintain stability in extreme temperatures (cold or hot), e.g., at or below freezing (32 degrees Fahrenheit) and at or above 100 degrees Fahrenheit. Such stability in extreme temperatures is an improvement over current pesticides that need to be kept or stored at particular temperatures for stability and to remain effective.

In several embodiments, the pest repellent is applied to a plant (e.g., a plant surface). For example, the pest repellent may be applied to the leaves, stem, and/or roots of a plant. The pest repellent may be applied to various types of plants, including, for example, ornamental plants, vegetables, bushes, trees, perennials, and the like.

In several embodiments, the pest repellent is applied to a plant at a certain time of day, season (e.g., certain month(s)), and/or at a certain temperature for effective application. In some embodiments, the pest repellent is applied to vegetation in the morning. For example, application of the pest repellent in the morning may be more effective for controlling the Japanese beetle since it is dormant at night. In some embodiments, the pest repellent is applied to vegetation before Japanese beetle activity is present, e.g., prior to common high activity periods for Japanese beetles, such as in late June or July. As an example, the pest repellent may be applied to vegetation in mid to late June. In some embodiments, cooler temperatures may be preferable for more effective results. For example, the pest repellent may be applied when temperatures are at or below 70 degrees Fahrenheit.

In several embodiments, the pest repellent is applied one or more times a week. The pest repellent may be applied once a week, twice a week, three times a week, and the like. The pest repellent may be applied more frequently during high activity periods for Japanese beetles, such as in late June or July. The pest repellent may be applied when Japanese beetle activity is first observed.

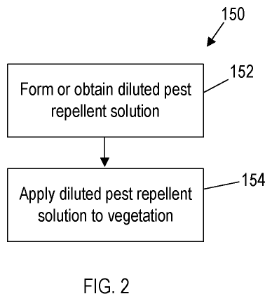

FIG. 2 is a flow chart showing a method of treating vegetation to repel pests (e.g., the Japanese beetle). The method 150 begins with operation 152 and a diluted solution of pest repellent is obtained (e.g., if previously formed) or formed by mixing concentrated pest repellent solution (e.g., pest repellent solution 100 depicted in FIG. 1) with water. For example, the concentrated pest repellent solution may be mixed with water as discussed in detail above to form the diluted pest repellent solution (e.g., with one or two ounces of concentrated pest repellent solution per gallon of water). The diluted pest repellent solution may be agitated to evenly mix the concentrated pest repellent solution and water together. In some embodiments, the pest repellent is obtained as a diluted solution (e.g., if premixed). In some embodiments, operation 152 may be omitted and a concentrated pest repellent solution may be used.

After operation 152, the method 150 may proceed to operation 154 and the diluted pest repellent solution is applied to vegetation (e.g., to a plant surface). For example, the diluted pest repellent solution may be sprayed or otherwise dispersed onto the vegetation. The diluted pest repellent solution may be applied as discussed in more detail above, for example, at certain times of day, certain times of year (certain month(s)), certain temperatures, certain days or amounts per week, and the like. The diluted pest repellent solution may be applied at times based on Japanese beetle activity.

### Examples

Various experimental trials were performed to test the efficacy and effectiveness of the pest repellent, particularly in repelling the Japanese beetle. The trials included various adjustments to the essential oils used in the mixture and their concentrations. In initial trials, sesame oil and garlic oil were tested with the mixture, separately and together. The oils added a harsh and unpleasant odor to the pest repellent and did not provide much improvement to the effectiveness of the repellent. Accordingly, these oils were removed from the mixture.

In one trial, adding capsaicin oil and eucalyptus oil to the pest repellent composition improved the effectiveness of the pest repellent. Specifically, adding the capsaicin oil significantly improved the effectiveness of the pest repellent against the Japanese beetle. While Japanese beetle activity was reduced by the pest repellent that included eucalyptus oil but omitted capsaicin oil, Japanese beetle activity was still observed. When capsaicin oil was added to the mixture, no Japanese beetle activity was observed. In other words, Japanese beetles did not land on plants treated with the pest repellent that included capsaicin oil. The Japanese beetles continued to land on nearby untreated vegetation, while leaving the treated vegetation untouched.

Determining a proper and effective concentration of capsaicin oil was difficult due to its volatility. Initial trials used higher concentrations of capsaicin oil, which had harmful effects (e.g., burning) for both plants and humans. The concentration of capsaicin oil was slowly reduced through various trials until a concentration was achieved that was most effective at controlling the Japanese beetle without causing harm to plants or humans.

In one trial, mugwort oil was added to the mixture. Mugwort oil is typically used as a mosquito repellent, but not in conjunction with the Japanese beetle. Surprisingly, mugwort oil acted as a Japanese beetle repellent when used in combination with other essential oils in the pest repellent mixture.

In trials that excluded glycerin, the pest repellent was unstable and required constant mixing. When left for periods of time (e.g., overnight), the mixture separated regardless of temperature. When glycerin was added to the pest repellent, significant improvement in stability was observed.

The addition of both glycerin and alcohol to the pest repellent resulted in improvements in the stability of the diluted pest repellent solution when the concentrated solution was mixed with water. When combined with water, the concentrated solution including glycerin and alcohol mixed throughout the water and did not bead or separate.

Various experimental trials were conducted to determine an effective amount and timing for application of the pest repellent to effectively eliminate pests, including the Japanese beetle, while avoiding harm to the plants. Application in the morning and at lower temperatures (e.g., at or below 70 degrees Fahrenheit) appeared to be most effective at reducing or eliminating Japanese beetle activity.

Although various embodiments of the claimed invention have been described above with a certain degree of particularity, or with reference to one or more individual embodiments, other embodiments of the present invention will become apparent to those skilled in the art from the detailed description and those skilled in the art could make numerous alterations to the disclosed embodiments without departing from the spirit or scope of the present invention. Other embodiments are therefore contemplated. It is intended that all matter contained in the above description and shown in the accompanying drawings shall be interpreted as illustrative only of particular embodiments and not limiting or restrictive. Changes in detail, structure, or composition may be made without departing from the basic elements of the invention as defined in the following claims.

We claim:

1. A composition for use in repelling pests from vegetation, the composition comprising:
two or more essential oils, wherein the two or more essential oils comprise capsaicin oil in a concentration that is effective at reducing or eliminating pest activity on the vegetation without harming the vegetation, wherein the pest activity comprises Japanese beetle activity;
a mixing agent; and
a surfactant.

2. The composition of claim 1, wherein the capsaicin oil is no more than 10.6% of the composition.

3. The composition of claim 1, wherein the capsaicin oil is no more than 400 mL per 1 gallon of the composition.

4. The composition of claim 1, wherein the two or more essential oils further comprise eucalyptus oil.

5. The composition of claim 4, wherein the capsaicin oil and eucalyptus oil are included in a ratio of 2:1.

6. The composition of claim 1, wherein the two or more essential oils comprise one or more essential oils from the genera Eucalyptus, Mentha, Artemisia, and Cedrus.

7. The composition of claim 1, wherein the two or more essential oils comprise one or more of eucalyptus oil, wormwood oil, peppermint oil, wintergreen oil, spearmint oil, mugwort oil, tea tree oil, and cedarwood oil.

8. The composition of claim 1, wherein the composition is a concentrated solution.

9. The composition of claim 8, wherein the capsaicin oil is about 9.5% to about 10.6% of the concentrated solution, and the two or more essential oils comprise one or more of eucalyptus oil that is about 4% to about 10% of the concentrated solution, wormwood oil that is about 1% to about 6% of the concentrated solution, peppermint oil that is about 1% to about 6% of the concentrated solution, wintergreen oil that is about 1% to about 6% of the concentrated solution, and mugwort oil that is about 1% to about 6% of the concentrated solution.

10. The composition of claim 8, wherein the two or more essential oils in a gallon of concentrated solution comprise 400 mL capsaicin oil, 200 mL eucalyptus oil, 120 mL wormwood oil, 100 mL peppermint oil, 100 mL wintergreen oil, and 80 mL mugwort oil.

11. The composition of claim 8, wherein the concentrated solution is mixed with water in a ratio of 1 to 2 ounces of concentrated solution to 1 gallon of water, forming a diluted solution that is applied to a plant surface to repel pests comprising the Japanese beetle.

12. The composition of claim 8, wherein the mixing agent comprises 99% isopropyl alcohol that is about 15% to about 25% of the concentrated solution, and the surfactant comprises glycerin that is about 45% to about 55% of the concentrated solution.

13. A method of treating vegetation to repel pests, the method comprising:
applying a pest repellent composition to one or more plants to repel one or more pests;
wherein the pest repellent composition comprises two or more essential oils, a mixing agent, and a surfactant, and wherein the two or more essential oils comprise capsaicin oil in a concentration of no more than about 10.6% of the composition.

14. The method of claim 13, wherein the capsaicin oil is in a concentration of no less than about 9.5% of the composition to effectively reduce a presence of Japanese beetles on the one or more plants.

15. The method of claim 13, wherein the one or more pests comprise Japanese beetles, and wherein applying the pest repellent composition to the one or more plants comprises applying the pest repellent composition at a time comprising at least one of:
before Japanese beetle activity is present;
a morning time when Japanese beetle activity is present;
when temperatures are at or below 70 degrees Fahrenheit; and
a high activity period for Japanese beetles, wherein the pest repellent composition is applied more frequently during the high activity period.

16. The method of claim 13, further comprising diluting the pest repellent composition with water prior to applying the pest repellent composition.

17. The method of claim 13, wherein the two or more essential oils further comprise eucalyptus oil.

18. A method of treating vegetation to effectively repel the Japanese beetle, the method comprising:
applying a pest repellent composition to one or more plants to repel the Japanese beetle;
wherein the pest repellent composition comprises two or more essential oils, a mixing agent, and a surfactant, wherein the two or more essential oils comprise capsaicin oil in a concentration of no more than about 10.6% of the composition.

19. The method of claim 18, wherein applying the pest repellent to the one or more plants comprises applying the pest repellent before Japanese beetle activity is present to prevent the Japanese beetle from landing on the one or more plants.

20. The method of claim 18, wherein an appearance of the one or more plants is unaffected by applying the pest repellent to the one or more plants.
